(19) United States
(12) Patent Application Publication
(10) Pub. No.: US 2006/0096345 A1
(43) Pub. Date: May 11, 2006

(54) SAFETY CYLINDER ASSEMBLY FOR LOCK

(75) Inventor: Yu-Chi Chen, Pingtung City (TW)

Correspondence Address: NIKOLAI & MERSEREAU, P.A., 900 SECOND AVENUE SOUTH, SUITE 820, MINNEAPOLIS, MN, 55402, US

(73) Assignee: Rick Te-Yu Chen, Pasadena, CA (US)

(21) Appl. No.: 11/161,100

(22) Filed: Jul. 22, 2005

(30) Foreign Application Priority Data
Aug. 5, 2004 (TW) 93212471

(51) Int. Cl. E05B 27/04

(52) U.S. Cl. 70/493

(57) ABSTRACT

A lock includes a housing, a first cylinder positioned in the housing, and a second cylinder positioned in the housing and located in an inner side of the first cylinder. The housing includes two annular positioning grooves defined in an inner periphery thereof for positioning the first and second cylinders. The housing further includes a plurality of pin tumbler assemblies respectively received in pin tumbler holes in an outer periphery thereof. The first cylinder includes a keyhole and a plurality of pin tumbler holes. The second cylinder includes a keyhole aligned with the keyhole of the first cylinder and a plurality of pin tumbler holes. Each pin tumbler hole of the housing is aligned with an associated one of the pin tumbler holes of the first and second cylinders.

### BACKGROUND OF THE INVENTION

1. Field of the Invention

The present invention relates to a safety cylinder assembly. In particular, the present invention relates to a safety cylinder assembly for a lock.

2. Description of Related Art

U.S. Pat. No. 6,644,076 (Taiwan Utility Model Publication No. 510397) discloses a cylinder assembly for a door lock. The cylinder assembly comprises a housing, a cylinder, an actuating tongue, and a cap. The cylinder is securely held on the housing with a fastener and rotatably received in a through-hole in the housing. A recess is defined in an end of the cylinder. A curved channel is defined in a face defining the recess. A connecting portion is formed on a first end of the actuating tongue and is rotatably received in the recess in the cylinder. A protrusion protrudes from the first end of the actuating tongue and extends into the curved channel in the cylinder. The cap is mounted around the actuating tongue and secured to the other end of the cylinder. The cylinder can be easily assembled to or disassembled from the housing by attaching or removing the fastener.

Such a cylinder assembly avoids the problems of formation of threaded portions on the end of the cylinder and the cap as well as consideration of the structural strength of the threaded portions in conventional designs. Further, the housing and the cylinder can be formed with zinc alloy by injection molding, thereby largely cutting the manufacturing cost. Nevertheless, the strength of the cylinder and the housing is not improved such that the actuating tongue can be actuated by forcibly picking the cylinder.

### OBJECTS OF THE INVENTION

An object of the present invention is to provide a lock comprising a lock assembly with improved safety.

Another object of the present invention is to provide a lock with a safety pin to avoid unlocking by an improper key.

### SUMMARY OF THE INVENTION

A lock in accordance with the present invention comprises a housing, a first cylinder mounted in the housing, and a second cylinder mounted in the housing and located in an inner side of the first cylinder. The housing comprises a first annular positioning groove and a second annular positioning groove both defined in an inner periphery of the housing. The housing further comprises a plurality of pin tumbler holes in an outer periphery thereof. A pin tumbler assembly is received in each pin tumbler hole of the housing.

The first cylinder comprises a keyhole, a first positioning means mounted in an outer periphery of the first cylinder, and a plurality of pin tumbler holes defined in the outer periphery of the first cylinder. The first cylinder is positioned in the housing by the first positioning means. Each pin tumbler hole of the first cylinder is aligned with an associated one of the pin tumbler hole of the housing.

The second cylinder comprises a keyhole aligned with the keyhole of the first cylinder, a second positioning means mounted in an outer periphery of the second cylinder, and a plurality of pin tumbler holes defined in the outer periphery of the second cylinder. The second cylinder is positioned in the housing by the second positioning means. Each pin tumbler hole of the first cylinder is aligned with an associated one of the pin tumbler hole of the housing.

Since the cylinder assembly includes a first cylinder and a second cylinder that are positioned with reference to each other, unauthorized forcible picking of the first cylinder is avoided. Even if the first cylinder is damaged, the first cylinder would not be disengaged from the housing and may rotate freely to thereby protect the second cylinder.

Preferably, the first positioning means of the first cylinder is not aligned with the pin tumbler holes of the first cylinder along a longitudinal direction of the first cylinder.

Preferably, the second positioning means of the second cylinder is not aligned with the pin tumbler holes of the second cylinder along a longitudinal direction of the second cylinder.

Preferably, the first cylinder further comprises an annular groove in an outer periphery thereof, and the housing comprises a safety pin mounted therein, with the safety pin extending into the annular groove. The safety pin restrains rotation of an improper key inserted into the keyhole, avoiding unauthorized unlocking.

Preferably, the annular groove of the first cylinder is spaced from the first positioning means and the pin tumbler holes of the first cylinder.

Preferably, each pin tumbler assembly of the housing comprises a lower pin tumbler, an upper pin tumbler, and an elastic element.

Preferably, the first positioning means comprises a positioning hole defined in the outer periphery of the first cylinder, a positioning member received in the positioning hole, and an elastic element for biasing the positioning member into the first annular positioning groove of the housing.

Preferably, the second positioning means comprises a positioning hole defined in the outer periphery of the second cylinder, a positioning member received in the positioning hole, and an elastic element for biasing the positioning member into the second annular positioning groove of the housing.

Preferably, the lock further comprises an unlatching member for coupling with the second cylinder.

The lock may be a Euro-profile cylinder lock, an auxiliary lock, a lever lock, or a pad lock.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a first embodiment of a lock in accordance with the present invention;

FIG. 2 is a sectional view of the lock in FIG. 1;

FIG. 3 is a sectional view similar to FIG. 2, wherein a key is inserted into a keyhole of the lock;

FIG. 4 is a sectional view taken along plane 4-4 in FIG. 3;

FIG. 5 is a view similar to FIG. 4, illustrating unlocking by a proper key;

FIG. 6 is a view similar to FIG. 4, illustrating operation of the lock when trying to unlock by an improper key;

FIG. 7 is an exploded perspective view of a second embodiment of the lock in accordance with the present invention;

FIG. 8 is an exploded perspective view of a third embodiment of the lock in accordance with the present invention; and

FIG. 9 is an exploded perspective view of a fourth embodiment of the lock in accordance with the present invention.

### DETAILED DESCRIPTION OF THE PREFERRED EMBODIMENTS

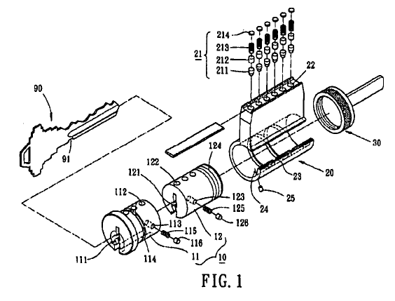

Referring to FIGS. 1 and 2, a first embodiment of a lock in accordance with the present invention comprises a cylinder assembly 10, a housing 20, and an unlatching member 30. The cylinder assembly 10 comprises a first cylinder 11 and a second cylinder 12. The first cylinder 11 comprises a keyhole 111, a plurality of pin tumbler holes 112, a positioning hole 113, and an annular groove 114. A flange (not labeled) is formed on a first end of the first cylinder 11. The flange rotatably abuts against an end face of a first end of the housing 20 when the first cylinder 11 is mounted in the housing 20.

The keyhole 111 extends longitudinally from the first end through a second end of the first cylinder 11, allowing a proper key 90 to inserted therethrough. The pin tumbler holes 112 are defined in an outer periphery of the first cylinder 11 and in communication with the keyhole 111. The pin tumbler holes 112 are aligned along a longitudinal direction of the first cylinder 11. The positioning hole 113 is defined in the outer periphery of the first cylinder 11 and not aligned with the pin tumbler holes 112 along the longitudinal direction of the first cylinder 11. A positioning means is mounted in the positioning hole 113. In this embodiment, the positioning means includes a positioning member 116 and an elastic element 115 for biasing the positioning member 116 partially out of the positioning hole 113. The positioning hole 113 can be deemed as a part of the positioning means. The annular groove 114 is defined in the outer periphery of the first cylinder 11 and spaced from the tin tumbler holes 112 and the positioning hole 113.

The second cylinder 12 is mounted in the housing 20 and on an inner side of the first cylinder 11. A first end of the second cylinder 12 rotatably abuts against the second end of the first cylinder 11. The second cylinder 12 comprises a keyhole 121, a plurality of pin tumbler holes 122, a positioning hole 123, and a threaded portion 124.

The keyhole 121 extends longitudinally from the first end through a second end of the second cylinder 12. Further, the keyhole 121 of the second cylinder 12 is aligned with the keyhole 111 of the first cylinder 11. The pin tumbler holes 122 are defined in an outer periphery of the second cylinder 12 and in communication with the keyhole 121 of the second cylinder 12. The pin tumbler holes 122 are aligned along a longitudinal direction of the second cylinder 12. The positioning hole 123 is defined in the outer periphery of the second cylinder 12 and not aligned with the pin tumbler holes 122 of the second cylinder 12 along the longitudinal direction of the second cylinder 12. A positioning means is mounted in the positioning hole 123. In this embodiment, the positioning means includes a positioning member 126 and an elastic element 125 for biasing the positioning member 126 partially out of the positioning hole 123. The positioning hole 113 can be deemed as a part of the positioning means. The threaded portion 124 is defined in the outer periphery of the second cylinder 12 and adjacent to the second end of the second cylinder 12. The threaded portion 124 is provided for threadedly engaging with the unlatching member 30.

The housing 20 comprises a plurality of pin tumbler assembly 21, a plurality of pin tumbler holes 22, two annular positioning grooves 23, and a radial hole 24. Each pin tumbler assembly 21 includes a lower pin tumbler 211, an upper pin tumbler 212, an elastic element 213, and an end piece 214. The lower pin tumbler 211, the upper pin tumbler 212, and the elastic element 213, of each pin tumbler assembly 21 is mounted into an associated pin tumbler hole 22 and sealed by the end piece 214 and a lid (not labeled) to avoid falling of the pin tumbler assembly 21.

The annular positioning grooves 23 are defined in an inner periphery of the housing 20 and respectively aligned with the positioning holes 113 and 123 respectively of the first cylinder 11 and the second cylinder 12. The radial hole 24 extends through the housing 20 and aligned with the annular groove 114 of the first cylinder 11.

As illustrated in FIG. 2, the second cylinder 12 and the first cylinder 11 are placed into the housing 20 in sequence, with the threaded portion 124 of the second cylinder 20 threadedly engaged with the unlatching member 30. In the illustrated embodiment, the unlatching member 30 comprises an actuating tongue (not labeled) and a ring (not labeled). The cylinder assembly 10 and the unlatching member 30 may turn jointly relative to the housing 20.

Each pin tumbler hole 22 is aligned with an associated one of the pin tumbler holes 112 and 122 of the first and second cylinders 11 and 12. Thus, each pin tumbler assembly 21 is aligned with an associated one of the pin tumbler holes 112 and 122 of the first and second cylinders 11 and 12. As illustrated in FIG. 2, when the key 90 is not inserted into the keyholes 111 and 121, the cylinder assembly 10 could not turn relative to the housing 20 due to the location of the upper pin tumblers 212 and the lower pin tumblers 211, which is conventional.

The positioning hole 113 receiving the elastic element 115 and the positioning member 116 of the first cylinder 11 is aligned with one of the annular positioning grooves 23 of the housing 20 whereas the positioning hole 123 receiving the elastic element 125 and the positioning member 126 of the second cylinder 12 is aligned with the other annular positioning groove 23 of the housing 20. The positioning members 116 and 126 are respectively biased by the elastic elements 115 and 125 into the annular positioning grooves 23 of the housing 20. Thus, the first cylinder 11 and the second cylinder 12 are positioned relative to the housing 20, preventing the first cylinder 11 and the second cylinder 12 from disengaging from the housing 20. The engaging reliability between the cylinder assembly 10 and the housing 20 is improved.

The safety pin 25 is then inserted through the radial hole 24. The length of the safety pin 25 is larger than the wall thickness of the housing 20. Thus, the safety pin 25 extends into the annular groove 114 of the first cylinder 11. In a case that the first cylinder 11 is damaged during unauthorized forcible picking, the first cylinder 11 could not be removed from the housing 20. Namely, the damaged first cylinder 11 would rotate freely in the housing 20. Thus, the second cylinder 12 is well protected. Picking and unauthorized unlocking are avoided. Even if the first cylinder 11 is removed from the housing 20, damage to the second cylinder 12 is still difficult to achieve, as the second cylinder 12 is deep inside the housing 20.

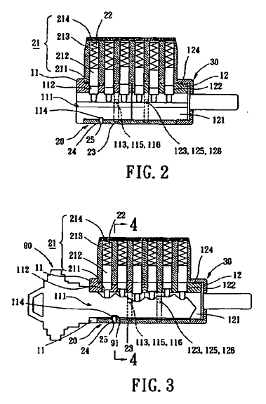

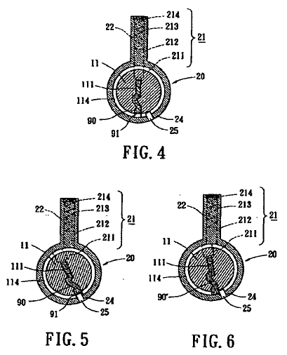

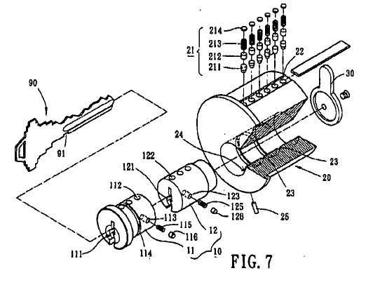

Referring to FIGS. 3 and 4, when a proper key 90 is inserted through the keyholes 111 and 121, the teeth (not labeled) of the proper key 90 pushes the lower pin tumblers 211 to the shear line (not labeled), allowing the cylinder assembly 10 to turn relative to the housing 20. The proper key 90 includes a notch 91 in a side thereof. The notch 91 of the proper key 90 is located in a longitudinal position corresponding to that of the safety pin 25. Thus, the notch 91 allows the proper key 90 to pass through the safety pin 25 when the proper key 90 is turned for unlocking purposes, as shown in FIG. 5. However, if an improper key 90′ is inserted into the keyholes 111 and 121, rotation of the improper key 90′ is stopped by the safety pin 25, as the improper key 90′ does not have the notch 91, as shown in FIG. 6. An additional safety device is thus provided.

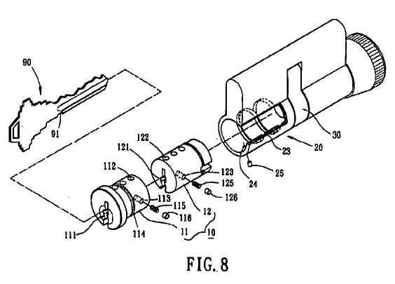

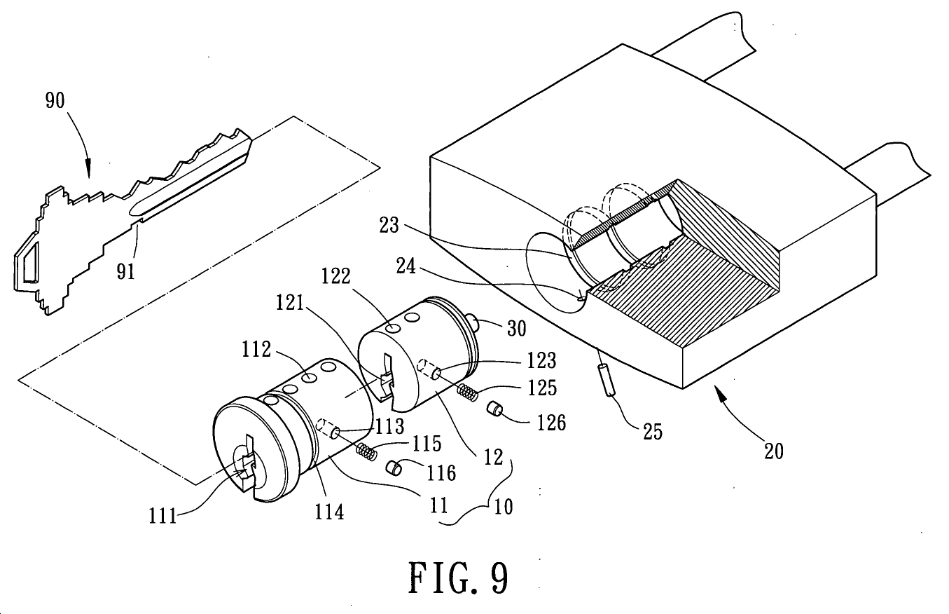

The lock shown in FIGS. 1 through 6 is a Euro-profile cylinder lock (or Swiss cylinder lock). Nevertheless, the lock in accordance with the present invention can be used with an auxiliary lock (FIG. 7), a lever lock (FIG. 8), a pad lock (FIG. 9), or other locks.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

what is claimed is:

1. A lock comprising:
a housing comprising a first annular positioning groove and a second annular positioning groove both defined in an inner periphery of the housing, the housing further comprising a plurality of pin tumbler holes in an outer periphery thereof, a pin tumbler assembly being received in each said pin tumbler hole of the housing;
a first cylinder mounted in the housing, the first cylinder comprising a keyhole, a first positioning means mounted in an outer periphery of the first cylinder, and a plurality of pin tumbler holes defined in the outer periphery of the first cylinder, the first cylinder being positioned in the housing by the first positioning means, each said pin tumbler hole of the first cylinder being aligned with an associated one of the pin tumbler hole of the housing; and
a second cylinder mounted in the housing and located in an inner side of the first cylinder, the second cylinder comprising a keyhole aligned with the keyhole of the first cylinder, a second positioning means mounted in an outer periphery of the second cylinder, and a plurality of pin tumbler holes defined in the outer periphery of the second cylinder, the second cylinder being positioned in the housing by the second positioning means, each said pin tumbler hole of the first cylinder being aligned with an associated one of the pin tumbler hole of the housing.

2. The lock as claimed in claim 1, wherein the first positioning means of the first cylinder is not aligned with the pin tumbler holes of the first cylinder along a longitudinal direction of the first cylinder.

3. The lock as claimed in claim 1, wherein the second positioning means of the second cylinder is not aligned with the pin tumbler holes of the second cylinder along a longitudinal direction of the second cylinder.

4. The lock as claimed in claim 1, wherein the first cylinder further comprises an annular groove in an outer periphery thereof, and wherein the housing comprises a safety pin mounted therein, with the safety pin extending into the annular groove.

5. The lock as claimed in claim 4, wherein the annular groove of the first cylinder is spaced from the first positioning means and the pin tumbler holes of the first cylinder.

6. The lock as claimed in claim 1, wherein each said pin tumbler assembly of the housing comprises a lower pin tumbler, an upper pin tumbler, and an elastic element.

7. The lock as claimed in claim 1, wherein the first positioning means comprises a positioning hole defined in the outer periphery of the first cylinder, a positioning member received in the positioning hole, and an elastic element for biasing the positioning member into the first annular positioning groove of the housing.

8. The lock as claimed in claim 1, wherein the second positioning means comprises a positioning hole defined in the outer periphery of the second cylinder, a positioning member received in the positioning hole, and an elastic element for biasing the positioning member into the second annular positioning groove of the housing.

9. The lock as claimed in claim 1, wherein the lock further comprises an unlatching member for coupling with the second cylinder.

10. The lock as claimed in claim 1, wherein the lock is selected from a group consisting of a Euro-profile cylinder lock, an auxiliary lock, a lever lock, and a pad lock.
